(19) United States
(12) Patent Application Publication
(10) Pub. No.: US 2010/0282491 A1
(43) Pub. Date: Nov. 11, 2010

(54) FLUORESCENT CABLE

(76) Inventors: Jorge Antonio Cofre Luna, Santiago (CL); Jorge Villablanca, Santiago (CL); Fernando Munoz, Santiago (CL)

Correspondence Address: SOFER & HAROUN LLP., 317 MADISON AVENUE, SUITE 910, NEW YORK, NY, 10017, US

(21) Appl. No.: 12/463,778

(22) Filed: May 11, 2009

(51) Int. Cl. H01B 7/00; H01B 3/30; H01B 7/295

(52) U.S. Cl. 174/113 R; 174/110 SR

(57) ABSTRACT

The present invention relates to a power and/or telecommunication cable (1) including one or several conductor elements (10,20,30) surrounded by an outer sheath (40,50) characterized in that said outer sheath comprises a first layer (40) made of a fluorescent material, and a second layer (50) made of a transmitting light thermoplastic polyurethane (TPU) material surrounding the first layer, so that the first layer is visible through the second layer.

### BACKGROUND

1. Field of the Invention

The present invention relates to power and/or telecommunication cable comprising a layer made of a fluorescent material.

More particularly, the power and/or telecommunication cable is used in mines and similar applications such as severe abrasion and dark environment.

2. Description of Related Art

A conventional power or telecommunication cable includes one or more conductor elements, especially insulated conductor elements, with a protective outer sheath. An electrical power cable is typically constructed with conductor elements formed of copper wire for efficiently conducting electrical power on whatever scale is desired. A telecommunication cable is typically constructed of relatively small wire conductor elements for conducting electrical signals and/or fiber-optic strands for conducting optical signals.

Power and telecommunication cables are used in many environments. One of the harshest environments for cables is mining operations in dark environment. In particular, the cables used in mining operations tend to be subjected to severe abrasion due to equipment, traffic, and mining materials moving over or along the mining cable. In addition, the lack of cable visibility in said dark environment frequently produces cable crushing or abrasive wearing by the mining trucks and the shovel machines.

Technical solutions already exist to visualize the cable so that the cable is less subjected to severe abrasion. In this respect, two variants are well-known.

The first variant consists in using an outer sheath such as an outer rubber sheath pigmented with a fluorescent pigment. However, said outer sheath presents low durability of the fluorescent pigments due to direct exposure to the ground, air, water and UV light.

The second variant is to use a reflective tape helically wrapped over the outer sheath of the cable. However, said additional reflective tape risks to be easily destructed due to severe use in mining conditions.

### OBJECTS AND SUMMARY

The present invention seeks to solve the above-mentioned problems of the prior art, and proposes a cable showing both high abrasion resistance and a good visibility in dark environment, more particularly in outdoor dark environment.

To this end, an object of the present invention is to provide a power and/or telecommunication cable including one or several conductor elements surrounded by an outer sheath, characterized in that said outer sheath comprises:
a first layer made of a fluorescent material, and
a second layer made of a transmitting light thermoplastic polyurethane (TPU) material surrounding the first layer, so that the first layer is visible through the second layer. More particularly, the fluorescent material of the first layer is visible through the second layer in dark environment.

The fluorescent material of the first layer absorbs light in order to emit light in dark environment. So, once the cable according to the invention is exposed with light, it is able to emit light in dark environment. For example, positioning in outdoor environment, the cable can be energized with sunlight during the day and emit the absorbed light during the night.

The transmitting light material is such the fluorescent material of the first layer can be seen through the second layer as if there was substantially no intervening material. By way of example, a material which transmits light can be a translucent material or a transparent material.

One understands that the second layer made of transmitting light TPU material is a transmitting light layer.

The two layer-outer sheath of the cable of the invention allows advantageously to provide a very resistant outer sheath which is visible in dark environment.

In addition, the cable according to the invention satisfies to the ICEA S-75-381-2008 standard concerning “Portable and power feeder cables for use in mines and similar applications”.

In a first variant, the second layer can be directly in contact with the first layer, or in other terms, there is no intermediate layer positioned between the first layer and the second layer.

In a second variant, the cable further comprises an intermediate layer along the cable between the first layer and the second layer, so that the first layer is visible through the intermediate layer. In this respect, said intermediate layer can be another transmitting light layer or a reinforcing open material. For example, the reinforcing open material can be an open mesh such as threads used as double serving.

According to the invention, the first layer made of fluorescent material can be a coated tape wherein the outer surface of said tape is coated with fluorescent ink. For example, the tape material as such is selected among cotton fabric, crosslinked acrylic compound on polyester/nylon substrate and other appropriate fabrics.

The first layer can also be an extruded layer made of a thermoplastic polymer including fluorescent pigments.

The second layer made of a transmitting light TPU material can be an extruded TPU layer which is obtained by an extrusion process well-known in the art.

In a specific embodiment, the TPU material can be crosslinked. Crosslinking processes are well-known in the art and one example can be to crosslink the TPU material in presence of X-radiation.

The second layer can further comprise a flame retardant filler selected among triphenylphosphate, tertbutylphenyl diphenyl phosphate and tertbutylated diphenyl phosphate, or mixtures thereof, to obtain a flame retardant layer, and more particularly a halogen free flame retardant (HFFR) second layer. Said flame retardant filler does advantageously not affect transparency of said second layer.

The thickness of the second layer as well as the nature and quantity of fillers in the material of second layer is such as the second layer keeps substantially a sufficient transparency to visualize the fluorescent material in dark environment. In this respect, the man skilled in the art is able to perform trials to find the optimum or workable second layer by routine experimentations.

### BRIEF DESCRIPTION OF THE DRAWINGS

The present invention will become more fully understood from the detailed description given herein below and from the accompanying drawing which is given by way of illustration only, and thus, which is not limits of the present invention, and wherein:

FIG. 1 represents a schematic cross-sectional view of an embodiment of a cable according to the invention, favorable for use as a mining cable.

### DETAILED DESCRIPTION

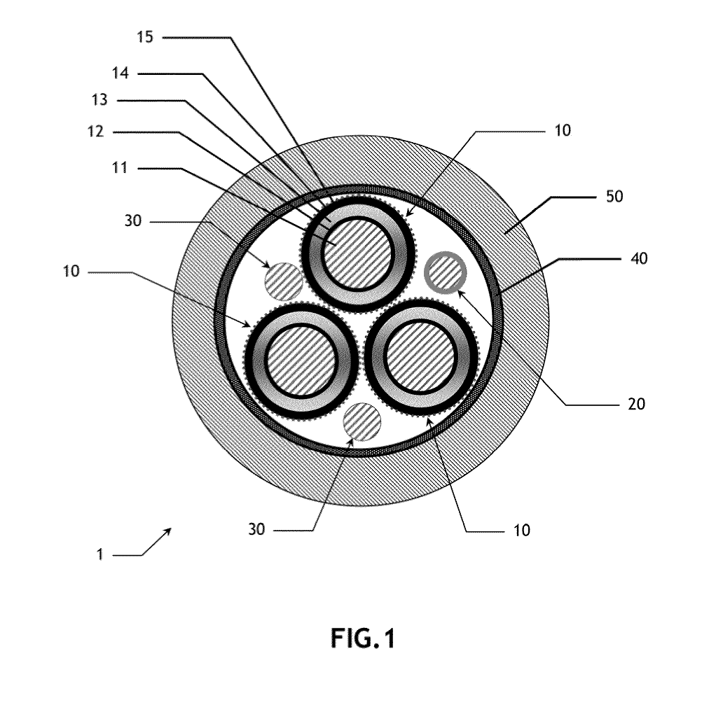

Referring to FIG. 1, the cable 1 includes a plurality of conductor elements 10,20,30, said plurality of elements being surrounded by an outer protective sheath 40,50 according to the invention. Said cable schematically illustrates a SHD, shielded round three-conductor cables (5001 to 25000 Volts) according to ICEA S-75-381-2008 standard, part 3.10.3.2.

The insulated conductor elements comprise three power insulated conductors 10, one ground check insulated conductor 20 and two grounded uninsulated conductors 30. A power insulated conductor 10 is for example composed of a plurality of stranded conductor wires 11 surrounded successively by a first semiconductor layer 12, a dielectric insulation 13, a second semiconductor layer 14, and a shield 15.

The outer protective sheath 40,50 is a two-layer sheath according to the invention. The inner layer 40 is a fluorescent tape on which the outer layer 50 of transmitting light thermoplastic polyurethane is directly in contact with the inner layer 40 in order to see visually the inner layer through the outer layer in a dark environment.

In addition, the cable according to the invention can comprise an reinforcing open material such as nylon threads (not represented) between the inner layer and the outer layer.

The cable of FIG. 1 illustrates a cable having a circular cross section. However, the circular cross section is given by way of illustration, and thus other forms can be considered such as for example a flat cross section.

The cable represented on FIG. 1 is manufactured such as the power insulated conductors 10, the ground check insulated conductor 20 and the grounding uninsulated conductors 30 are gathered to form an assembly. Then, the inner layer 40, and eventually the reinforcing nylon threads, are applied over said assembly. Finally, a transmitting light thermoplastic polyurethane material is extruded around the fluorescent tape, or around the reinforcing nylon threads if existed, to form the outer layer 50 of the outer sheath.

In this example, the inner layer is a fluorescent tape commercialized by Loypos under the reference Fluorescent Tape, the inner layer having a thickness of about 0.20 mm. The transmitting light thermoplastic polyurethane is commercialized by Lubrizol under the reference Estane ZHF 80AT3 NAT 021 or by AlphaGary under the reference Irogran A78P 4766NM, the extruded thermoplastic polyurethane having a thickness of about 7.5 mm. The reinforcing nylon threads are commercialized by Synthetic Thread Co Inc., under the reference Nylon 1050/3 Ply Preshrunk. The outer sheath according to the invention can be defined according to outer sheath thickness in the part 3.21.2 of ICEA S-75-381-2008 standard, and according to cable outside diameters in the part 3.22 of ICEA S-75-381-2008 standard. The additional threads between the two layers of the outer sheath are provided according part 3.21.2 of ICEA 5-75-381-2008 standard.

1. Power and/or telecommunication cable including one or several conductor elements surrounded by an outer sheath, said sheat comprising:
a first layer made of a fluorescent material, and
a second layer made of a transmitting light thermoplastic polyurethane (TPU) material surrounding the first layer, so that the first layer is visible through the second layer.

2. Cable according to claim 1, wherein the second layer is directly in contact with the first layer.

3. Cable according to claim 1, further comprising an intermediate layer along the cable between the first layer and the second layer, so that the first layer is visible through the intermediate layer.

4. Cable according to claim 1, wherein the first layer is a coated tape wherein the outer surface of said tape is coated with fluorescent ink.

5. Cable according to claim 1, wherein the first layer is an extruded layer made of a thermoplastic polymer including fluorescent pigments.

6. Cable according to claim 1, wherein the second layer is an extruded TPU layer.

7. Cable according to claim 1, wherein the second layer is crosslinked.

8. Cable according to claim 1, wherein the second layer further comprises a flame retardant filler.
